(19) United States
(12) Patent Application Publication
(10) Pub. No.: US 2025/0006942 A1
(43) Pub. Date: Jan. 2, 2025

(54) LITHIUM ION BATTERY WITH ZERO VOLTAGE RECOVERY FUNCTION AND METHODS FOR PRODUCING THE SAME

(71) Applicant: American Lithium Energy Corporation, Carlsbad, CA (US)

(72) Inventors: Jiang FAN, San Diego, CA (US); Chentao YU, Sunnyvale, CA (US); Linhua HU, San Marcos, CA (US)

(21) Appl. No.: 18/753,854

(22) Filed: Jun. 25, 2024

Related U.S. Application Data
(60) Provisional application No. 63/511,282, filed on Jun. 30, 2023.

(51) Int. Cl. H01M 4/62; H01M 4/04; H01M 4/66; H01M 10/04; H01M 10/0525; H01M 10/0587; H01M 50/566; H01M 50/609

(52) U.S. Cl. CPC H01M 4/628; H01M 4/0404; H01M 4/661; H01M 10/0431; H01M 10/049; H01M 10/0525; H01M 10/0587; H01M 50/566; H01M 50/609

(57) ABSTRACT

A method for producing a battery cell may include forming a positive electrode and a negative electrode before interposing a separator therebetween. A disk of a non-lithium sacrificial material, such as zinc (Zn), may be secured to a case. A sheet of materials including the separator interposed between the positive electrode and the negative electrode may be inserted into the case, either wound into a jellyroll or left as is. In some cases, a negative tab extending from the negative electrode may be extended through an opening in the disk of non-lithium sacrificial material. The negative tab may then be welded to the disk and the case of the battery cell to provide an electrical connection between the negative electrode and the non-lithium sacrificial material as well as an electrical connection between the negative electrode and a negative terminal of the battery cell.

### CROSS REFERENCE TO RELATED APPLICATION

This application claims priority to U.S. Provisional Application No. 63/511,282, entitled “LITHIUM ION BATTERY WITH ZERO-VOLTAGE RECOVERY FUNCTION AND METHODS FOR PRODUCING THE SAME” and filed on Jun. 30, 2023, the disclosures of which are incorporated herein by reference in their entireties.

### TECHNICAL FIELD

The subject matter described herein relates generally to battery technology and more specifically to protective mechanisms for a battery cell subjected to low-voltage exposure or zero-voltage exposure.

### BACKGROUND

Metal ion battery cells, such as lithium ion (Li⁺) battery cells, exhibit high energy density and high current output. As such, metal ion battery cells are suitable for a variety of high energy and high power applications. However, metal ion battery cells are also susceptible to internal morphological deformations caused by parasitic reactions that occur during the charging and discharging of the metal ion battery cell. The development of internal morphological deformations may diminish the capacity and cycle life of the metal ion battery cell. Even more critically, some internal morphological deformations, such as the formation of dendrites on the electrodes of the metal ion battery cell, may give rise to significant safety hazards. For example, dendrite growth can penetrate the separator in a metal ion battery cell to form an internal short circuit between the negative electrode (anode) and positive electrode (cathode) of the metal ion battery cell. Internal short circuits are a leading cause of thermal runways, a catastrophic chain reaction in which undissipated heat from an overheating battery cell accelerates exothermic reactions within the battery cell to further increase the temperature of the battery. The consequences of thermal runaway include fires and explosions that are especially difficult to contain.

### SUMMARY

Systems and methods for producing battery cells with zero-volt recovery function are provided. In some implementations of the current subject matter, there is provided a method for producing a battery cell with zero-volt recovery function. The method may include: forming a positive electrode; forming a negative electrode; interposing a separator between the positive electrode and the negative electrode to form a sheet of materials; securing, to a case, a disk comprising a non-lithium sacrificial material; inserting, into the case, the sheet of materials; extending, through an opening in the disk, a negative tab extending from the negative electrode; and welding the negative tab to the disk and the case to provide (i) an electrical connection between the negative electrode and the non-lithium sacrificial material, and (ii) an electrical connection between the negative electrode and a negative terminal of the battery cell.

In some variations, one or more features disclosed herein including the following features can optionally be included in any feasible combination.

In some variations, the forming of the positive electrode may include applying, to a metal foil comprising a positive current collector, a slurry including one or more materials comprising the positive electrode.

In some variations, the forming of the negative electrode may include applying, to a metal foil comprising a negative current collector, a slurry including one or more materials comprising the negative electrode.

In some variations, the non-lithium sacrificial material may have a lower decomposition voltage than the metal foil comprising the negative current collector.

In some variations, the metal foil comprising the negative current collector may be a copper (Cu) foil, and wherein the non-lithium sacrificial material is zinc (Zn).

In some variations, the method may further include: wounding the sheet of materials including the separator interposed between the positive electrode and the negative electrode to form a jellyroll; and inserting, into the case of the battery cell, the jellyroll.

In some variations, the method may further include: inserting, into a case, a layer of insulator material such that the insulator material is interposed between the disk of the non-lithium sacrificial material and the sheet of materials including the separator interposed between the positive electrode and the negative electrode.

In some variations, the disk may include an insulator material layered with the non-lithium sacrificial material. The disk may be secured to the case with the insulator material interposed between the non-lithium sacrificial material and the sheet of materials including the separator interposed between the positive electrode and the negative electrode.

In some variations, the method may further include: welding, to the case, a positive tab extending from the positive electrode, the positive tab is weld to a positive terminal of the battery cell while the negative tab is weld to a negative terminal of the battery cell.

In some variations, the method may further include: filling the case with an electrolyte before sealing the case.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a horizontal cross-sectional view of an example of a battery cell consistent with implementations of the current subject matter;

FIG. 1B depicts a vertical cross-sectional view of an example of a battery cell consistent with implementations of the current subject matter;

FIG. 2A depicts a schematic diagram illustrating an example of a battery cell consistent with implementations of the current subject matter;

FIG. 2B depicts a schematic diagram illustrating another example of a battery cell consistent with implementations of the current subject matter;

FIG. 2C depicts a schematic diagram illustrating an example of a battery cell consistent with implementations of the current subject matter;

FIG. 3A depicts a schematic diagram illustrating an example of a negative electrode that is stacked with a sacrificial electrode consistent with implementations of the current subject matter;

FIG. 3B depicts a schematic diagram illustrating an example of a negative electrode that is stacked with a sacrificial electrode consistent with implementations of the current subject matter;

FIG. 4 depicts a schematic diagram illustrating an example of a composite tab consistent with implementations of the current subject matter;

FIG. 5A depicts a schematic diagram illustrating an example of a case with a sacrificial coating layer consistent with implementations of the current subject matter;

FIG. 5B depicts a schematic diagram illustrating another example of a case with a sacrificial coating layer consistent with implementations of the current subject matter;

FIG. 6 depicts a cross sectional view of an example of an electrode with a porous current collector consistent with implementations of the current subject matter;

FIG. 7 depicts a flowchart illustrating a process for producing a battery cell consistent with implementations of the current subject matter;

FIG. 8A depicts a graph illustrating the capacity and direct current resistance (DCR) of a battery cell consistent with implementations of the current subject matter before and after zero-voltage exposure;

FIG. 8B depicts a graph illustrating the voltage profile of a battery cell consistent with implementations of the current subject matter during the course of zero-voltage exposure;

FIG. 8C depicts a graph illustrating the cycle life of a battery cell consistent with implementations of the current subject matter after zero-voltage exposure; and

FIG. 8D depicts a graph illustrating the voltage-capacity profile of a battery cell consistent with implementations of the current subject matter at 20% depth of discharge.

When practical, similar reference numbers denote similar structures, features, or elements.

### DETAILED DESCRIPTION

A metal ion battery cell, such as a lithium ion (Li⁺) battery cell, may be over discharged when the metal ion battery cell is discharged beyond a minimum voltage. Discharging a conventional metal ion battery cell to a low-voltage or zero-voltage state may destabilize the metal ion battery cell and cause a variety of irreversible damages to critical components of the battery cell. For example, the solid electrolyte interface (SEI) may decompose in a conventional metal ion battery cell that is discharged to a low-voltage state or a zero-voltage state. The degradation of the solid electrolyte interphase (SEI), which prevents electrolyte decomposition and sustain electrochemical reactions within the metal ion battery cell by enabling the transport of metal ions (e.g., lithium (Li) ions and/or the like) while blocking the transport of electrons and further reaction between the electrolyte and negative electrode, may cause irreversible capacity loss at the metal ion battery cell. Moreover, a metal ion battery cell with a degraded solid electrolyte interphase (SEI) may exhibit a higher impendence and is thus able to provide less power to its load because more power is being dissipated as heat by the internal resistance of the metal ion battery cell.

Discharging a conventional metal ion battery cell to a low-voltage state or a zero-voltage stage may also cause the negative current collector of the metal ion battery cell to undergo an anodic corrosion, which depletes metal ions from the negative current collector. Metal ions from the negative current collector may dissolve into the electrolyte of the metal ion battery cell, travel through the separator, and accumulate on the positive electrode of the metal ion battery cell. Meanwhile, during a subsequent recharging of the battery cell, the depleted metal ions may again dissolve into the electrolyte before being deposited on the surface of the negative electrode. The resulting change in the internal morphology of the metal ion battery cell, which includes metal dendrites formed by the accumulation of metal ions on the negative electrode, may degrade the capacity of the metal ion battery cell. Moreover, an internal short circuit may develop within the metal ion battery cell when the metal dendrites formed on the surface of the negative electrode puncture the separator and come in contact with the positive electrode of the metal ion battery cell.

Low-voltage and zero-voltage instability is detrimental for applications in which the metal ion battery cell is transported and stored for prolonged periods of time. For example, even in the absence of active use, a metal ion battery cell may still over discharge due to self-discharge, power consumption by a battery management system, and/or parasitic loads. In other cases, imbalances in a serially connected cluster of metal ion battery cells may inadvertently over discharge one or more of the metal ion battery cells in the cluster. The ability to preserve structural integrity while a metal ion battery cell is in a prolonged low-voltage or zero-voltage state may be desirable at least because fully or partially discharging the metal ion battery cell is a reliable mechanism for reducing fire risks during storage and transportation of the metal ion battery cell. That is, a metal ion battery cell that is discharged to a low-voltage or zero-voltage state is far less likely to catch fire than one that is more fully charged but, as noted, maintaining the metal ion battery cell in the low-voltage or zero-voltage state for a prolonged period of time may cause irreversible structural damage (e.g., solid electrolyte interphase (SEI) decomposition, anodic corrosion, and/or the like) that renders the metal ion battery cell unusable.

Some conventional countermeasures against structural degradation in a low-voltage or zero-voltage state, such as pre-lithiating the negative electrode of a lithium (Li) ion battery cell, merely counteract the loss of lithium that occurs during the manufacturing process and are not economically viable at scale. Pre-lithiation, which includes applying a lithium powder to the surface of battery electrodes (e.g., anodes), can render the electrode highly reactive and thus require an inert manufacturing environment (e.g., dry room). Manufacturing complexity notwithstanding, conventional countermeasures against structural degradation in a low-voltage or zero-voltage state simply do not provide adequate protection against the corrosion of the negative electrode when a metal ion battery cell is in a low-voltage or a zero-voltage state for an extended period of time. For example, in the case of pre-lithiation, only the minimum quantity of surplus lithium (e.g., less than 20% by weight) necessary to compensate for the lithium that is lost during the initial charge and discharge cycle is used in order to avert the risk of converting a lithium ion battery cell into a lithium metal battery cell. The current collector remains vulnerable to anodic corrosion because this surplus lithium is exhausted during the initial charge and discharge cycle. As such, pre-lithiation alone is not sufficient to protect the current collector from anodic corrosion after the initial charge and discharge cycle. Furthermore, the instability of lithium outside of an inert manufacturing environment (e.g., dry room) renders the use of surplus lithium generally unsuitable for manufacturing at scale. Thus, what is lacking in the current state-of-the-art is a reliable and economical mechanism for preventing structural degradation in a metal ion battery cell that is maintained in a low-voltage or zero-voltage state for an extended period of time. Such mechanisms may be especially advantageous for high volume and low cost manufacturing of metal ion battery cells that can be transported and stored in a low-voltage or zero-voltage state for improved fire safety.

Various implementations of the present disclosure provide a metal ion battery cell that incorporates a non-lithium based mechanism for low-voltage or zero-voltage recovery as well as a process for producing the same at scale. The aforementioned shortcomings of surplus lithium as a countermeasure against structural degradation in a low-voltage or zero-voltage stage are obviated with the use of a non-lithium based alternative. For example, according to some implementations of the current subject matter, a metal ion battery cell may include one or more sacrificial electrodes formed from a non-lithium material having a lower decomposition voltage (or electric potential) than the material of the negative current collector coupled with the negative electrode (or anode) of the metal ion battery cell. Where the negative current collector is formed from copper (Cu), the one or more sacrificial electrodes may be formed from a metal (e.g., tin (Sn), lead (Pb), cadmium (Cd), aluminum (Al), zinc (Zn), magnesium (Mg), and/or the like), a galvanized metal, a metal alloy (e.g., steel), or a galvanized metal alloy. In some cases, the manufacturability and production cost of a low-voltage or zero-voltage stable metal ion battery cell may be further enhanced by the form factor and strategic placement of one or more non-lithium sacrificial electrodes in the metal ion battery cell. For instance, in some cases, a metal ion battery cell may include a non-lithium sacrificial electrode in the form of a non-lithium wafer (or disk) that can be easily deposited into the case of the metal ion battery cell before (or after) the insertion of the jellyroll or, alternatively, coupled to an exterior of the case of the metal ion battery cell. Alternatively, in some cases, the non-lithium sacrificial electrode may be a layer of a non-lithium material coating at least a portion of an interior surface or an exterior surface of the case of the metal ion battery cell.

In some implementations of the current subject matter, the one or more sacrificial electrodes may be electrically coupled with the negative electrode (anode) but not the positive electrode (cathode) of the metal ion battery cell. For example, the one or more sacrificial electrodes may be coupled directly with the negative electrode of the metal ion battery cell or indirectly through a metal case of the metal ion battery cell in cases where the metal case of the metal ion battery cell is coupled with the negative electrode. The one or more sacrificial electrodes may prevent a decomposition of the negative current collector and/or the solid electrolyte interphase (SEI) when the metal ion battery cell is in a low-voltage state or a zero-voltage state. For instance, when the metal ion battery cell is in a low-voltage state or a zero-voltage state, the sacrificial electrodes may decompose instead of the negative current collector and/or the solid electrolyte interphase (SEI), thereby preserving the structural integrity of the metal ion battery cell. Even in cases where the dissolved sacrificial electrodes accumulate on the surface of the positive electrode (during the discharging of the battery cell) or on the surface of the negative electrode (during the recharging of the battery cell), the materials forming the sacrificial electrodes may accumulate more uniformly and are thus resistant to forming dendrites on the surfaces of the electrodes. As such, the one or more sacrificial electrodes may preserve the internal morphology of the battery cell, thus maintaining the capacity and cycle life of the metal ion battery cell even when the metal ion battery cell is maintained in a low-voltage state or a zero-voltage state for an extended period of time. In other words, a metal ion battery cell incorporating various implementations of non-lithium sacrificial electrodes described herein may be discharged to a low voltage or zero voltage state to increase its safety profile during transportation and storage. Even after prolonged periods of time in the low voltage or zero voltage state, the metal ion battery cell may remain useable upon recovery from the low-voltage and zero-voltage state.

In some implementations of the current subject matter, the metal ion battery cell may include one or more porous current collectors. For example, the negative current collector and/or the positive current collector of the metal ion battery cell may be formed from a porous material such as an expanded metal foil, a perforated foil, or a composite carbon-based foil (e.g., carbon fiber, graphene, and/or the like). As noted, the one or more sacrificial electrodes may be incorporated in the metal ion battery cell in a variety of manner including, for example, as a wafer (or disc) of non-lithium material deposited in the case of the metal ion battery cell before (or after) the insertion of the jellyroll or, alternatively, coupled to an exterior of the case of the metal ion battery cell. Alternatively and/or additionally, the sacrificial electrode may be a layer of non-lithium material coating at least a portion of an interior surface or an exterior surface of the case of the metal ion battery cell. The porosity of the current collectors may reduce diffusion length by several orders of magnitude by providing a shorter, more direct path for the metal ions from the one or more sacrificial electrodes to reach the active electrodes in the metal ion battery cell. For instance, with porous current collectors, metal ions from the one or more sacrificial electrodes may diffuse directly across the layers of current collectors to the active electrodes rather than being forced to diffuse along the length of the current collectors and electrodes.

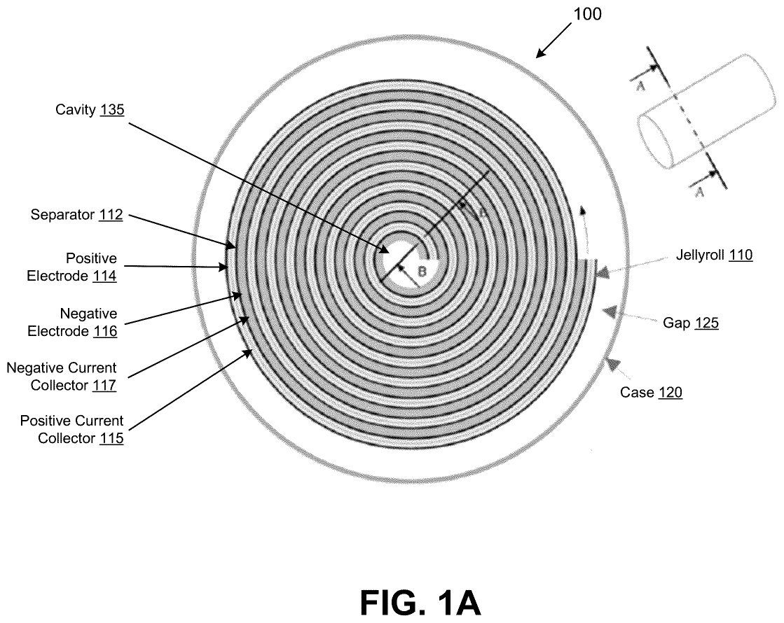

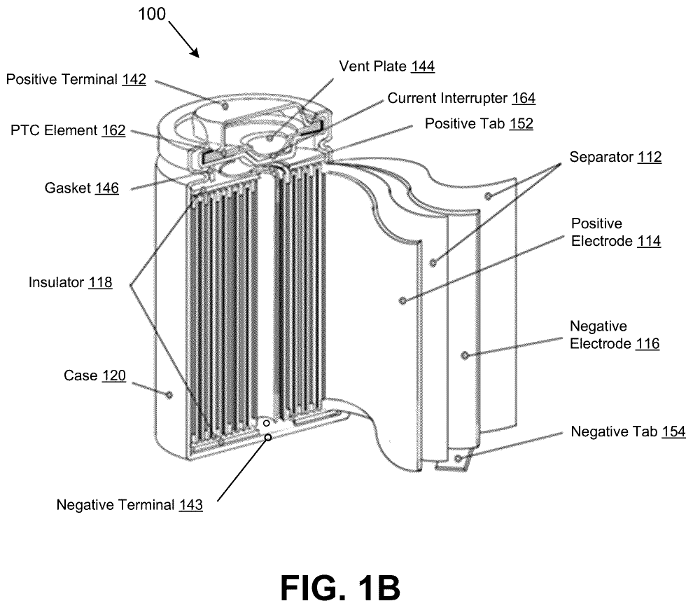

FIGS. 1A-B depict an example of a battery cell 100 consistent with implementations of the current subject matter. A horizontal cross-section view of the battery cell 100 is depicted in FIG. 1A while a vertical cross-section view of the battery cell 100 is depicted in FIG. 1B. In some implementations of the current subject matter, the battery cell 100 may be a metal ion battery cell including, for example, a lithium ion (Li⁺) battery cell, a sodium ion (Na⁺) battery cell, a magnesium ion (Mg²⁺) battery cell, an aluminum ion (Al³⁺) battery cell, and/or the like. As shown in FIGS. 1A-B, the battery cell 100 may include a jellyroll 110 disposed inside a case 120. In the example shown in FIGS. 1A-B, the battery cell 100 is a cylindrical battery cell with the case 120 being a rigid (non-flexible), metallic case that is substantially cylindrical in shape. However, it should be appreciated that the present disclosure also contemplates other formats of the battery cell 100 including, for example, prismatic battery cell, pouch battery cell, button battery cell, and/or the like. In some cases, instead of a rigid (non-flexible), metallic case, the case 120 may be a flexible, non-rigid case formed from a metallic or non-metallic material.

In some implementations of the current subject matter, the jellyroll 110 may be formed by winding multiple layers of materials for a separator 112, a positive electrode (cathode) 114, a positive current collector 115, a negative electrode (anode) 116, and a negative current collector 117. For example, in some cases, a layer of material for the separator 112 may be interposed between a layer of material for the positive electrode (cathode) 114 and a layer of material for the negative electrode (anode) 116 to prevent direct contact therebetween. In some cases, another layer of material for the separator 112 may be applied on top of either the layer of material for the positive electrode (cathode) 114 and or the layer of material for the negative electrode (anode) 116 to prevent either electrode materials from contacting itself in the jellyroll 110. In some cases, a layer of material for the positive current collector 115 (e.g., a sheet of aluminum (Al) foil) may be applied to either the surface of the layer of material for the positive electrode (cathode) 114 or disposed in the center of the positive electrode (cathode) material. Likewise, a layer of material for the negative current collector 117 (e.g., a sheet of copper (Cu) foil) may be applied to either the surface of the layer of material for the negative electrode (anode) 116 or disposed in the center of the negative electrode (anode) material. The resulting stack, which may include at least the aforementioned layers of materials, may be wound to form the jellyroll 110. FIG. 1A shows that, in some cases, a cavity 135 may be present in the center of the jellyroll 110, which may be due to the jellyroll 110 having been wound around a mandrel. In some cases, inadvertent contact between the jellyroll 110 and one or more interior surfaces of the case 120 may be avoided by including a gap 125 as well as placing one or more layers of material for an insulator 118 therebetween. Avoiding such contact may prevent the formation of an internal short circuit when the case 120, which is typically metallic, comes in contact with the positive electrode (cathode) material and the negative electrode (anode) material in the jellyroll 110.

Referring now to FIG. 1B, in some cases, the battery cell 100 may further include a positive terminal 142 on a proximate end of the battery cell 100 and a negative terminal 143 on a distal end of the battery cell 100. In some cases, a positive tab 152 may electrically couple the positive electrode 114 to the positive terminal 142 such that the battery cell 100 is electrically coupled to a load (e.g., external circuit) when the positive terminal 142 is coupled with the positive terminal of the load. Similarly, a negative tab 154 may electrically couple the negative electrode 116 to the negative terminal 143 such that the battery cell 100 is electrically coupled to the load (e.g., external circuit) when the negative terminal 143 is coupled with the negative terminal of the load.

In some implementations of the current subject matter, the battery cell 100 may include one or more safety mechanisms to reduce the risk of fire and explosion in the event of a thermal runaway. For example, in some cases, the battery cell 100 may include a vent plate 144 and a gasket 146 that operate to relieve excess pressure buildup within the battery cell 100 by permitting the release of gases that may otherwise cause the battery cell 100 to explode. In some cases, the battery cell 100 may also include a positive temperature coefficient (PTC) element 162 whose conductivity is inversely proportional to the temperature of the battery cell 100. For instance, the positive temperature coefficient element 162 may include one or more positive temperature coefficient material such as, for example, polyethylene (PE) and carbon black, polyvinylidene fluoride (PVDF) and carbon black, an inorganic conductive ceramic (e.g., barium titanium oxide (BaTiO₃) and/or the like) and polyethylene (PE). Because the conductivity of the positive temperature coefficient element 162 decreases when the battery cell 100 is subject to rising temperatures, the positive temperature coefficient element 162 may serve to reduce current flow within the battery cell 100 when the battery cell 100 is subject to rising temperatures. Once the temperature of the battery cell 100 normalizes, the positive temperature coefficient element 162 may return to high conductivity. Alternatively and/or additionally, the battery cell 100 may include a current interrupter 164, which may be a fuse capable of permanently disrupt the flow of current within the battery cell 100 when the battery cell 100 is subject to excessive current, pressure, and/or voltage.

In some implementations of the current subject matter, the battery cell 100 may include one or more sacrificial electrodes formed from a non-lithium material having a lower electric potential (or decomposition voltage) than the material of the negative current collector 116. The inclusion of the one or more sacrificial electrodes may improve the stability of the battery cell 100 in a low-voltage or a zero-voltage state, which occurs when the battery cell 100 is discharged beyond a minimum voltage. In some cases, the one or more sacrificial electrodes may decompose, for example, through oxidation, when the battery cell 100 is in a low-voltage state or a zero-voltage state. Having a lower electric potential (or decomposition voltage) than the material of the negative current collector 116, the one or more sacrificial electrodes may decompose instead of the negative current collector 116 and/or the solid electrolyte interphase (SEI) of the battery cell 100. As such, the inclusion of the one or more sacrificial electrodes may preserve the capacity and cycle life of the battery cell 100 even when the battery cell 100 is discharged to a low-voltage state or a zero-voltage state. In some cases, discharging the battery cell 100 to a low-voltage or a zero-voltage state may improve its safety profile during transportation or storage but doing so in the absence of the one or more sacrificial electrodes may compromise the structural integrity of the battery cell 100. The presence of the one or more sacrificial electrodes may therefore preserve the structural integrity of the battery cell 100 while the battery cell 100 is rendered safe for transportation and storage by being discharged to a low-voltage or zero-voltage state.

As noted, the one or more sacrificial electrodes in the battery cell 100 may be formed from a non-lithium material having a lower electrical potential (or decomposition voltage) than the material of the negative current collector 116. In instances where the negative current collector 116 is formed from copper (Cu), the one or more sacrificial electrodes may be formed from a non-lithium material having a lower electric potential (or decomposition voltage) than +0.02 volts. Some examples of such materials, which include metals, metal alloys, galvanized metals, and galvanized metal alloys, are shown in Table 1 below. It should be appreciated that a non-lithium material may be used to form the one or more sacrificial electrodes to avoid the reactivity associated with lithium (Li). The highly reactive nature of lithium (Li) means that incorporating one or more lithium-based sacrificial electrodes to render the battery cell 100 low-voltage or zero-voltage stable would require the battery cell 100 to be produced in an inert manufacturing environment (e.g., dry room), which poses a significant cost and complexity hurdle for large scale, low cost production. By incorporating one or more non-lithium based sacrificial electrodes, which are more stable in an ambient environment, the battery cell 100 can be rendered electrochemically stable for prolonged periods of time in a low-voltage or zero-voltage state without increasing manufacturing complexity or cost.

TABLE 1

| Material | Electric Potential (Volts) |
|---|---|
| Copper (Cu) | +0.02 |
| Tin (Sn) | −0.26 |
| Active Stainless Steel (AISI 304) | −0.29 |
| Lead (Pb) | −0.31 |
| Steel | −0.46 |
| Cadmium (Cd) | −0.49 |
| Aluminum (Al) | −0.51 |
| Galvanized Steel | −0.81 |
| Zinc (Zn) | −0.86 |
| Magnesium (Mg) | −1.36 |

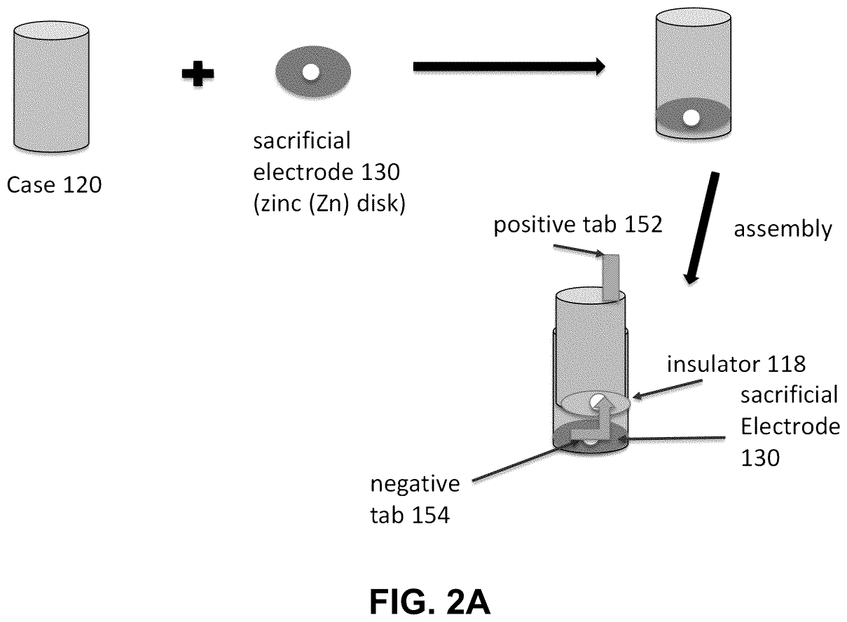

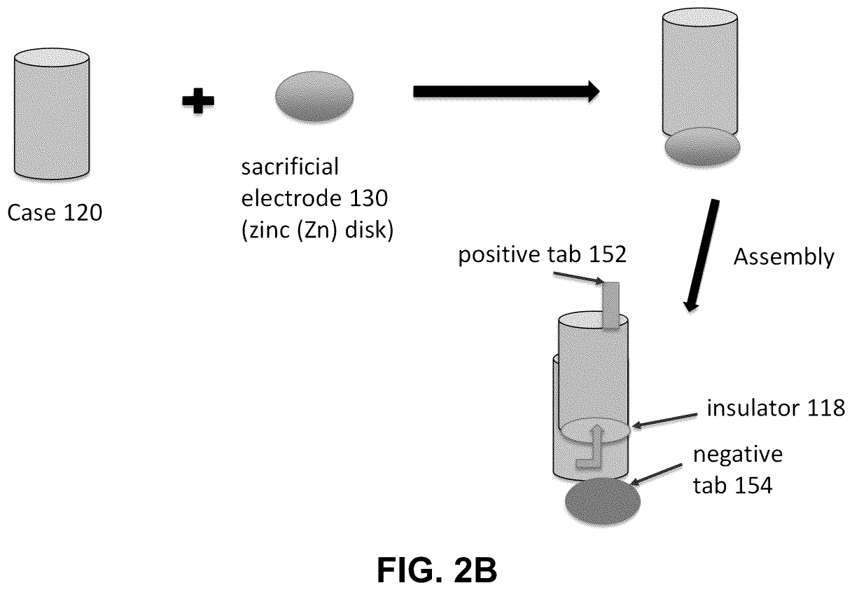

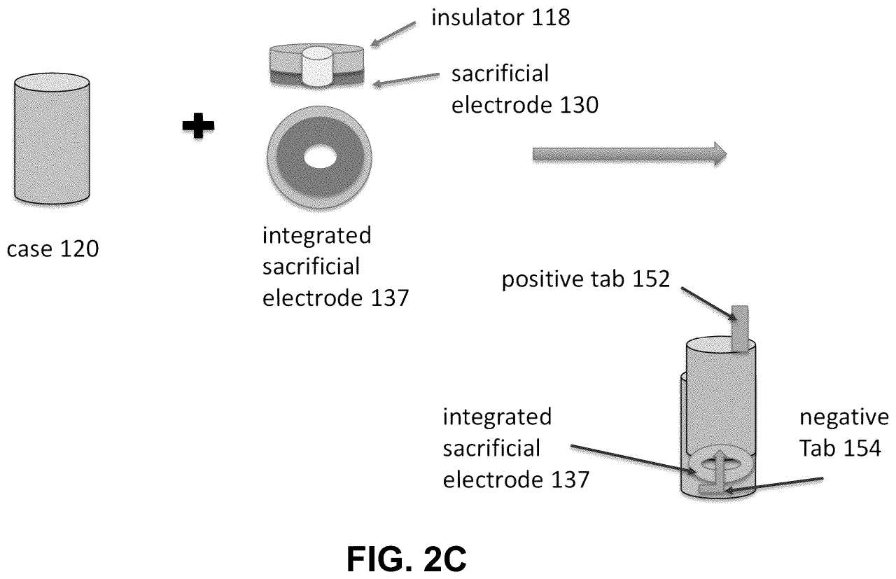

In some implementations of the current subject matter, the one or more non-lithium sacrificial electrodes may be in a form factor configured to further enhance the manufacturability of the battery cell 100 incorporating the one or more non-lithium sacrificial electrodes. FIG. 2A depicts one example of the battery cell 100 including a sacrificial electrode 130 in the form of a disk (or wafer) in a non-lithium material having a lower electrical potential (or decomposition voltage) than the material of the negative current collector 117. For example, in some cases, the sacrificial electrode 130 may be a zinc (Zn) disk that is inserted inside the case 120 followed by the jellyroll 110. In some cases, the sacrificial electrode 130 may be secured to one end of the case 120 (e.g., by welding) with a layer of the insulator 118 interposed between the sacrificial electrode 130 and one or more adjacent surfaces of the jellyroll 110. In the example shown in FIG. 2A, the negative tab 154 may extend through an opening in the layer of the insulator 118 in order to be in electric contact with the sacrificial electrode 130 and provide an electric coupling between the sacrificial electrode 130 and the negative electrode 116 such that the sacrificial electrode 130 can decompose instead of the negative current collector 117 when the battery cell 110 is in a low-voltage or zero-voltage state. Moreover, in some cases, the negative tab 154 may further extend through an opening in the sacrificial electrode 130 and secured to the case 120 (e.g., by welding) such that the negative tab 154 is in electric contact with the negative terminal 143 of the battery cell 100 and provide an electrical connection between the battery cell 100 and the load (e.g., external circuit) therethrough.

FIG. 2B depicts another variation of the battery cell 100 in which the sacrificial electrode 130 is secured to the exterior of the case 120. For example, in some cases, the sacrificial electrode 130 may be a disk (or wafer) of a non-lithium material (e.g., zinc (Zn) and/or the like) having a lower electrical potential (or decomposition voltage) than the material of the negative current collector 117. In this variation of the battery cell 100, the sacrificial electrode 130 may be secured (e.g., by welding) to an exterior of the case 120 of the battery cell 100. For instance, in the example shown in FIG. 2B, the sacrificial electrode 130 may be secured to a surface of the case 120 that is at a distal end of the battery cell 100 where the negative terminal 143 of the battery cell 100 is located. A layer of the insulator 118 may be interposed between the jellyroll 110 inside the case 120 and one or more interior surfaces of the case 120 to electrically isolate the jellyroll 110 from the case 120 as well as the sacrificial electrode 130 coupled with the case 120. The negative tab 154 may extend through an opening in the insulator 118 and secured to the case 120 (e.g., by welding). Configured as such, the negative tab 154 may provide an electric coupling between the sacrificial electrode 130 and the negative electrode 116 such that the sacrificial electrode 130 can decompose instead of the negative current collector 117 when the battery cell 110 is in a low-voltage or zero-voltage state. Furthermore, the negative tab 154 may be in electric contact with the negative terminal 143 of the battery cell 100 and provide an electrical connection between the battery cell 100 and the load (e.g., external circuit) therethrough.

FIG. 2C depicts another variation of the battery cell 100 in which the sacrificial electrode 130 and the insulator 118 are integrated to form an integrated sacrificial electrode 137. For example, in some cases, the integrated sacrificial electrode 137 may be a disk with a layer of the insulator 118 being disposed on a layer of a non-lithium material (e.g., zinc (Zn) and/or the like) forming the sacrificial electrode 130. In some cases, the integrated sacrificial electrode 137 may be secured to one end of the case 120 (e.g., by welding) with the surface that is the sacrificial electrode 137 oriented towards the interior surface of the case 120 and the surface that is the insulator 118 oriented towards the jellyroll 110 inside the case 120. The negative tab 154 may extend through an opening in the integrated sacrificial electrode 137 and secured to the case 120 (e.g., by welding). As such, the negative tab 154 may provide an electric coupling between the sacrificial electrode 130 and the negative electrode 116 such that the sacrificial electrode 130 can decompose instead of the negative current collector 117 when the battery cell 110 is in a low-voltage or zero-voltage state. Furthermore, the negative tab 154 may be in electric contact with the negative terminal 143 of the battery cell 100 and provide an electrical connection between the battery cell 100 and the load (e.g., external circuit) therethrough.

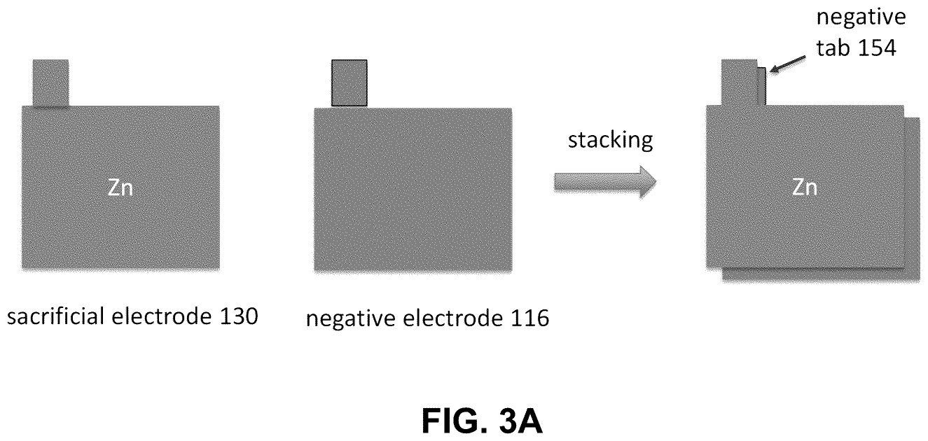

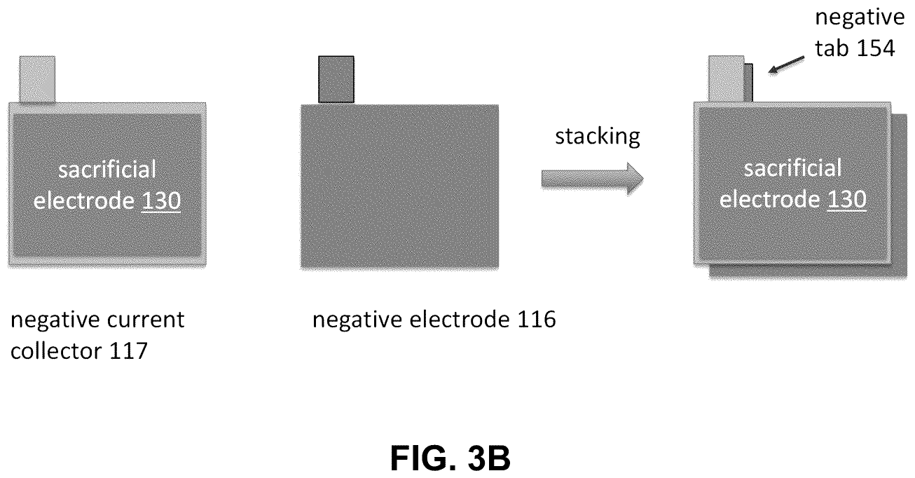

In some implementations of the current subject matter, the sacrificial electrode 130 may be integrated into the stack of materials including the layers of materials for the separator 112, the positive electrode (cathode) 114, the positive current collector 115, the negative electrode (anode) 116, and the negative current collector 117. FIG. 3A depicts one example of the battery cell 100 in which the sacrificial electrode 130 is a sheet of non-lithium material (such as the zinc (Zn) shown) that is layered (or stacked) with the material for the negative electrode (anode) 116. FIG. 3B depicts another example of the battery cell 100 in which the sacrificial electrode 130 is a sheet of non-lithium material (such as zinc (Zn)) that is layered (or stacked) with the material for the negative current collector 117. In some cases, the material for the sacrificial electrode 130 may be secured to the negative electrode (anode) 116 and/or the negative current collector 117 by welding. Alternatively, the material for the sacrificial electrode 130 may be applied to at least a portion of the surface of the negative electrode (anode) 116 and/or the negative current collector 117 by techniques such as electroplating, metal deposition (e.g., atomic layer deposition (ALD), chemical vapor deposition (CVD), laser metal deposition (LMD), physical vapor deposition (PVD)), metal spraying, and/or the like. As shown in FIGS. 3A-B, the non-lithium material forming the sacrificial electrode 130 may or may not extend into the negative tab 154. The example depicted in FIG. 3A shows the non-lithium material of the sacrificial electrode 130 extending into the negative tab 154 such that the negative tab 154 includes the non-lithium material of the sacrificial electrode 130. FIG. 3B shows a different configuration of the sacrificial electrode 130 in which the material of the sacrificial electrode 130 does not extend into the negative tab 154 and the negative tab 154 therefore excludes the material of the sacrificial electrode 130. For certain formats of the battery cell 100, such as cylindrical and prismatic, the stack of materials including the non-lithium material of the sacrificial electrode 130 may be wound into the jellyroll 110 shown in FIGS. 1A-B and 2A-C. However, it should be appreciated that the stack of materials including the non-lithium material of the sacrificial electrode 130 may also be left as is, in its stacked form, for other formats of the battery cell 100 (e.g., pouch, button, and/or the like).

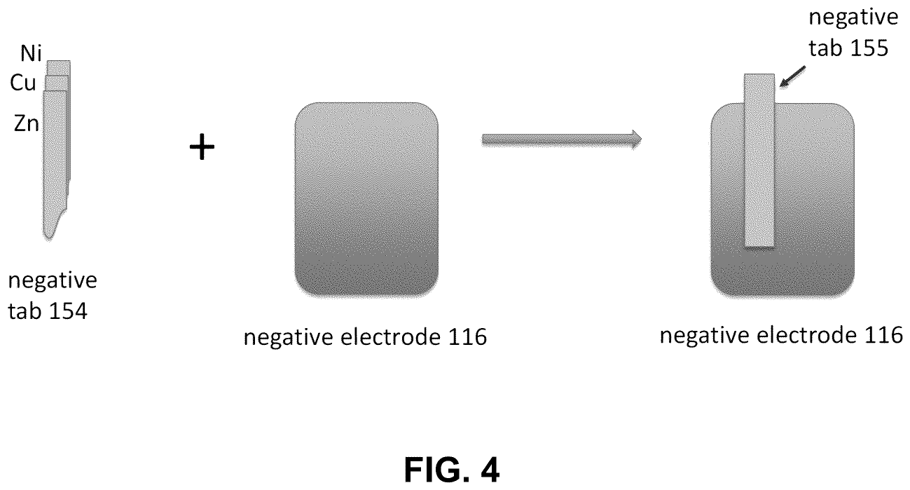

In some implementations of the current subject matter, the battery cell 100 may incorporate non-lithium sacrificial material in other form factors. FIG. 4 depicts one example in which a non-lithium sacrificial material (such as the zinc (Zn) shown) is incorporated into the negative tab 154 of the battery cell 100. In the example shown in FIG. 4, the non-lithium sacrificial material (such as the zinc (Zn) shown) is layered with one or more other materials (such as the copper (Cu) and nickel (Ni)) shown to form a composite. The resulting negative tab 155 may be coupled with the negative electrode 116, for example, by welding. Furthermore, the negative tab 155 may be secured to the case 120, for example, to the negative terminal 143 of the battery cell 100 in order to provide an electric connection between the battery cell 100 and the load (e.g., external circuit) when the negative terminal 143 is in electric contact with the negative terminal of the load (e.g., external circuit).

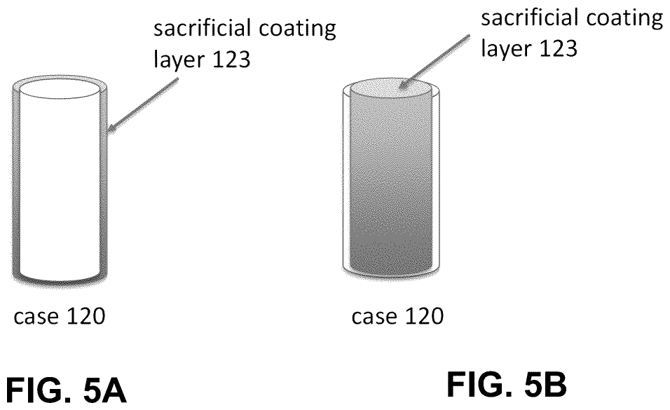

FIGS. 5A-B depict two additional examples of the battery cell 100 incorporating a sacrificial coating layer 123 formed from one or more non-lithium sacrificial material having a lower electrical potential (or decomposition voltage) than the material of the negative current collector 117. In the variation of the battery cell 100 shown in FIG. 5A, the sacrificial coating layer 123 is applied to at least a portion of an exterior surface of the case 120 of the battery cell 100. Alternatively and/or additionally, FIG. 5B shows that the sacrificial coating layer 123 can also be applied to at least a portion of an interior surface of the case 120 of the battery cell 100. It should be appreciated that the sacrificial coating layer 123 may be applied to the exterior surface and/or the interior surface of the case 120 using a variety of techniques including, for example, electroplating, metal deposition (e.g., atomic layer deposition (ALD), chemical vapor deposition (CVD), laser metal deposition (LMD), physical vapor deposition (PVD)), metal spraying, and/or the like. The sacrificial coating layer 123 may be electrically coupled to the negative electrode 116 of the battery cell 100 via the negative tab 154, which may be welded to the case 120 in instances where the sacrificial coating layer 123 is applied to the exterior surface of the case 120 or directly to the sacrificial coating layer 123 itself in instances where the sacrificial coating layer 123 is applied to the interior surface of the case 120.

In some implementations of the current subject matter, the battery cell 100 may include one or more mechanisms to improve the diffusion of metal ion therein, such as the diffusion of metal ion from the non-lithium sacrificial material incorporated into the battery cell 100. For example, in some cases, the material forming the positive current collector 115 and/or the negative current collector 117 may be porous and thus permeable to the metal ion diffusion. Otherwise, when the positive current collector 115 and the negative current collector 117 are impermeable to metal ion diffusion, impedance again metal ion diffusion may give rise to a gradient of metal ions within the battery cell 100 in which a disproportionately high concentration of metal ions aggregate near the non-lithium sacrificial material, which is the source of the metal ions. The porosity of the positive current collector 115 and the negative current collector 117 may be especially desirable for reducing the extremity of the aforementioned gradient in configurations where the sacrificial material is not disposed directly adjacent to the positive electrode 114. The configuration of the jellyroll 110, for example, requires metal ions to diffuse across multiple layers of the positive current collector 115 and the negative current collector 117. As noted, the non-lithium sacrificial material may decompose and release metal ions to the positive electrode 114 when the battery cell 100 is in a low-voltage or a zero-voltage state for an extended period of time. The porosity of the positive current collector 115 and the negative current collector 117 may improve the stabilizing effects of the sacrificial material decomposing instead of the negative current collector 117 by providing a more direct path for the metal ions to reach the positive electrode 114.

In some implementations of the current subject matter, the battery cell 100 may include a primer layer that is permeable to metal ion diffusion. For example, in some cases, the primer layer may formed from a material, such as a polymer, that is capable of absorbing electrolyte in order to provide ionic conductivity for faster diffusion of metal ions from the non-lithium sacrificial material. This primer layer may also facilitate the manufacturing of the battery cell 100, particularly in instances where the positive current collector 115 and/or the negative current collector 117 are formed from a porous material. For instance, during the coating process in which the slurry forming the negative electrode 116 is coated onto the negative current collector 117, the primer layer may block the pores present in the negative current collector 116 and thus prevent the slurry forming the negative electrode 116 from leaking through the pores during the coating process. In some cases, the primer layer may also contain one or more protective components or materials configured to respond to excessive voltage, pressure, and/or temperature at the battery cell 100.

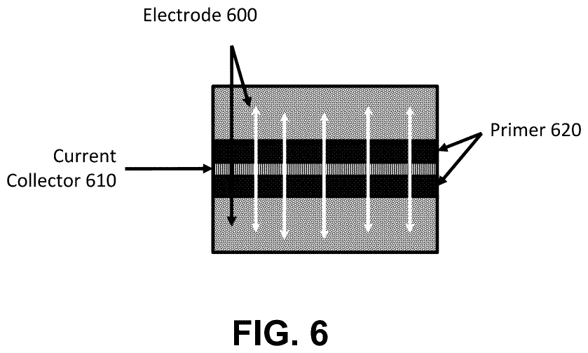

FIG. 6 depicts a cross sectional view of an example of an electrode 600 that is coupled with a current collector 610 and a primer layer 620 consistent with implementations of the current subject matter. In some cases, the example of the electrode 600 and the current collector 610 shown in FIG. 6 may implement the positive electrode (cathode) 114 and the positive current collector 115 and/or the negative electrode (anode) 116 and the negative current collector 117 in the battery cell 100. As shown in FIG. 6, the material forming the current collector 610 may be disposed between two layers of the material forming the electrode 600. Furthermore, the material forming the primer 620 may be disposed between two layers of the material forming the current collector 610. In some cases, the current collector 610 may be a porous current collector. For example, in some cases, the current collector 610 may include one or more sheets of metallic foil (e.g., copper (Cu) foil and/or the like) having a plurality of pores that shorten the diffusion pathway of metal ions (e.g., zinc ions (Zn²⁺) and/or the like) from the sacrificial material by at least providing a passageway through the current collector 610. Otherwise, when the current collector 610 is a non-porous and thus impermeable to metal ion diffusion, metal ions (e.g., zinc ions (Zn²⁺) and/or the like) from the sacrificial material may be required to travel around the current collector 610.

While the porosity of the current collector 610 is desirable for facilitating the metal ion diffusion, the porosity of the current collector 610 renders the current collector 610 penetrable to other substances including, for example, the slurry of material forming the electrode 600. Accordingly, in the example shown in FIG. 6, the primer layer 620 is interposed between the material of the current collector 610 to at least prevent a leakage of the slurry of material forming the electrode 600 through the pores present in the current collector 610. In some cases, the primer layer 620 may further include one or more protective components and/or materials configured to respond to an excessive voltage, pressure, and/or temperature. For example, the primer layer 620 may include a positive temperature coefficient material (e.g., polyethylene (PE) and carbon black, polyvinylidene fluoride (PVDF) and carbon black, an inorganic conductive ceramic (e.g., barium titanium oxide (BaTiO₃) and/or the like) and polyethylene (PE)) whose conductivity is inversely proportional to the temperature of the battery cell 100. Alternatively, the primer layer 620 may include a material that responds to an excessive voltage, pressure, and/or temperature by creating a nonconductive gap between the current collector 610 and one or more layers of the material for the electrode 600. For instance, the primer layer 620 may generate a gas and/or a liquid that further transitions to a gas when exposed to an excessive voltage, pressure, and/or temperature. The gas may generate the nonconductive gap by at least causing a delamination between the electrode 600 and the current collector 610. Alternatively and/or additionally, the gas and/or the liquid may generate the nonconductive gap by at least decomposing at least a portion of the electrode 600.

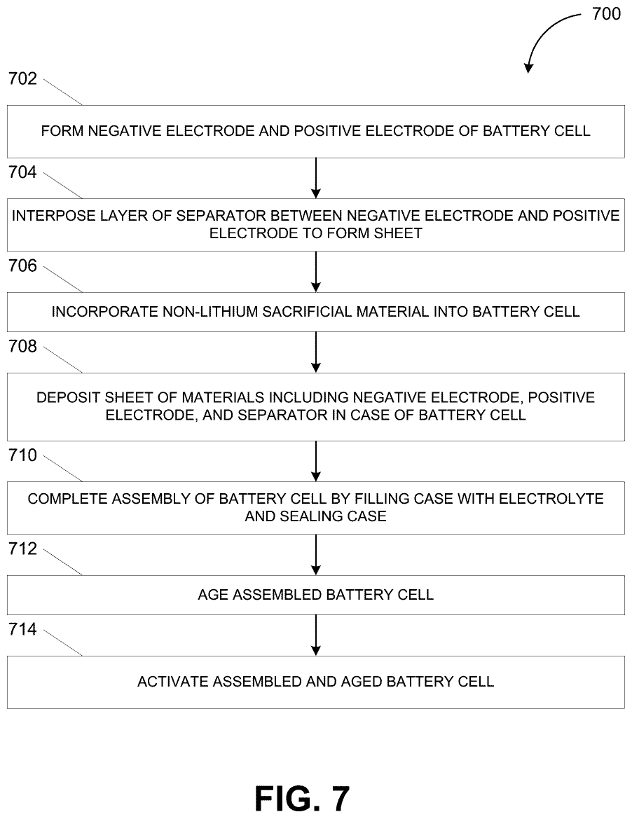

FIG. 7 depicts a flowchart illustrating a process 700 for assembling a battery cell consistent with implementations of the current subject matter. Referring to FIGS. 1A-B, 2A-C, 3A-B, 4, 5A-B, and 6-7, the process 700 may be performed to manufacture, for example, the battery cell 100 to include a non-lithium sacrificial material to render the battery cell 100 stable in a prolonged low-voltage or zero-voltage state. It should be appreciated that the operations in the process 700 may be performed in any order including, but not limited to, the order that is shown. One or more of the operations shown may be repeated, or, in some cases, omitted altogether.

At 702, the negative electrode and positive electrode of a battery cell are formed. For example, in some cases, the negative electrode and the positive electrode may be formed by punching sheets of electrode material into appropriately shaped and/or sized pieces using an electrode tab. The negative electrode and the positive electrode of the battery cell may be dried. For instance, in some cases, the positive electrode of the battery cell may be dried at 125° C. for 10 hours while the negative electrode of the battery cell may be dried at 140° C. for 10 hours.

At 704, a layer of separator is interposed between the positive electrode and the negative electrode to form a sheet. For example, a layer of separate may be laminated the positive electrode and the negative electrode of the battery cell to form a sheet. In some cases, metal foil (e.g., aluminum (Al)) for the positive current collector may be layered with the positive electrode while metal foil (e.g., copper (Cu)) for the negative current collector may be layered with the negative electrode. For some configurations, such as cylindrical battery cells and prismatic battery cells, the sheet of materials including the separator interposed between the positive electrode and the negative electrode may be wound to form a jellyroll. For other configurations, such as pouch battery cells, the sheet of materials including the separator interposed between the positive electrode and the negative electrode may be left as is for further assembly.

At 706, non-lithium sacrificial material is incorporated into the battery cell. In some implementations of the current subject matter, the battery cell may incorporate non-lithium sacrificial material, such as a metal, a galvanized metal, a metal alloy, and/or a galvanized metal alloy having a lower decomposition voltage (or electrical potential) than the material of the negative current collector in the battery cell. For a negative current collector formed from copper (Cu), for example, the non-lithium sacrificial material may be zinc or a zinc alloy. In some cases, the battery cell may incorporate the non-lithium sacrificial material in a variety of ways. For example, in some cases, a disk (or wafer) of the non-lithium sacrificial material may be secured to an interior surface or an exterior surface of the case of the battery cell before being electrically coupled, through the negative tab, with the negative electrode of the battery cell. In instances where the disk (or wafer) of the non-lithium sacrificial material is secured to an interior surface of the case of the battery cell, operation 706 may include inserting the disk (or wafer) of the non-lithium sacrificial material into the case and securing the disk (or wafer) of the non-lithium sacrificial material prior to inserting the sheet of materials including the separator interposed between the positive electrode and the negative electrode, either wound into a jellyroll or left as is. In some cases, a layer of insulator material may be interposed between the disk (or wafer) of the non-lithium sacrificial material and the sheet of materials including the separator interposed between the positive electrode and the negative electrode to prevent inadvertent contact therebetween. In some cases, operation 706 may include extending a negative tab from the negative electrode through an opening in the disk (or wafer) of non-lithium sacrificial material as well as, in some cases, a corresponding opening in the insulator material such that the negative tab can be secured to the case and be in electrical contact with a negative terminal of the battery cell. In some cases, the negative tab may also be in electrical contact with the disk (or wafer) of no-lithium sacrificial material such that the non-lithium sacrificial material is coupled with the negative electrode of the battery cell.

In some cases, the non-lithium sacrificial material may be incorporated into the sheet of materials including the separator interposed between the positive electrode and the negative electrode. For example, in some cases, a layer of the non-lithium sacrificial material may be stacked against the negative electrode in the sheet of materials including the separator interposed between the positive electrode and the negative electrode. Accordingly, in some cases, operation 706 may include applying the layer of the non-lithium sacrificial material to a surface of the negative electrode. In some cases, the layer of the non-lithium sacrificial material may or may not extend into the negative tab. Furthermore, in some cases, the layer of the non-lithium sacrificial material may be a part of a composite negative tab that includes other metals such as, for example, copper (Cu), nickel (Ni), and/or the like.

In some cases, the non-lithium sacrificial material is applied to the interior surface and/or exterior surface of the case of the battery cell. For example, in some cases, the non-lithium material may be applied to cover at least a portion of the interior surface and/or exterior surface of the case of the battery cell by electroplating, metal deposition (e.g., atomic layer deposition (ALD), chemical vapor deposition (CVD), laser metal deposition (LMD), physical vapor deposition (PVD)), metal spraying, and/or the like. In some cases, operation 706 may include applying the non-lithium material to the interior surface of the case of the battery cell before depositing the sheet of materials including the separator interposed between the positive electrode and the negative electrode either would into a jellyroll or left as is. Alternatively, operation 706 may include applying the non-lithium material to the exterior surface of the case of the battery cell, in which case operation 706 may be performed before or after the sheet of materials including the separator interposed between the positive electrode and the negative electrode is deposited into the case of the battery cell.

At 708, the sheet of materials including the negative electrode, the positive electrode, and the separator is deposited in the case of the battery cell. For example, the sheet of materials including the separator interposed between the positive electrode and the negative electrode or, in some cases, the jellyroll formed therefrom, may be placed inside a metallic (e.g., aluminum (Al)) case. In some cases, the sheet of materials including the separator interposed between the positive electrode and the negative electrode or, in some cases, the jellyroll formed therefrom may be dried inside the case. For instance, the sheet of materials including the separator interposed between the positive electrode and the negative electrode or, in some cases, the jellyroll formed therefrom may be dried at 70° C. for 10 hours. In some cases, subsequent to drying the sheet of materials including the separator interposed between the positive electrode and the negative electrode or, in some cases, the jellyroll formed therefrom, the case may be filled with electrolyte and sealed to complete the assembly of the battery cell at 710.

At 712, the assembled battery cell is aged. For example, the battery cell formed in operation 714 can be aged for 36 hours. At 714, the assembled and aged battery cell is activated (718). For instance, the battery cell may be activated by undergoing a formation process in which the battery cell is subject to a controlled charge and discharge cycle configured to activate the chemical components of the battery cell. This formation process may require the battery cell to be charged by being exposed to a gradually increasing current instead of a constant current such that the buildup of voltage within the battery cell is gradual.

### Sample Cell I (Zinc (Zn) Sacrificial Material Coupled to Battery Case)

The positive electrode of Sample Cell I was formed by dissolving a certain quantity of polyvinylidene difluoride (PVDF) in N-methylpyrrolidone (NMP) to prepare an 8% polymer solution. A certain quantity of carbon black was then added to the 8% polymer solution and mixed for 30 minutes at 6500 revolutions-per-minute to form a slurry. A certain quantity of high nickel lithium nickel manganese cobalt oxide was added the slurry and mixed for 30 minutes at 6500 revolutions-per-minute with N-methylpyrrolidone (NMP) added for viscosity adjustments during the mixing in order to achieve a flowable slurry. The flowable slurry was then coated onto an aluminum (Al) foil (e.g., 15-μm aluminum foil) using an automatic coating machine with the first heat zone set to approximately 80° C. and the second heat zone set to approximately 130° C. to evaporate the N-methylpyrrolidone (NMP). The positive electrode of Sample Cell I was formed by compressing the aluminum (Al) foil coated with the slurry to a target thickness and cutting to a target width (e.g., 56 millimeters). A positive tab was welded to a mass free zone at the center of the positive electrode.

The negative electrode of Sample Cell I was formed by dissolving a certain quantity of binder in deionized water and then a conductive additive is added and mixed for 30 minutes at 6500 revolutions-per-minute. A nano silicon (Si) and carbon composite were added to the resulting solution and mixed for 60 minutes at 6500 revolutions-per-minute. Additional water was added to adjust the viscosity of the solution and achieve a flowable slurry. The slurry was then be coated on to a copper (Cu) foil (e.g., 9-μm thick copper foil) using an automatic coater. The negative electrode of Sample Cell I was formed by compressing the copper (Cu) foil coated with the slurry to a target thickness and cutting to a target width (e.g., 58 millimeters). The negative tab was welded to the mass free zone of the negative electrode.

The jellyroll of Sample Cell I was formed to include a 56-mm wide positive electrode, a separator, and a 58-mm width negative electrode using a semi-automatic winding machine. A disk of zinc (Zn) metal was inserted into a 18650 case and attached to the bottom of the case. The jellyroll was then inserted into the case before the negative tab was welded to the bottom of the case and the positive tab was welded to the cell header by laser welding. The unfinished battery cell was dried at 80° C. for approximately 12 hours before being filled with a certain quantity of the electrolyte and sealed. The battery cell was then aged for 24 hours at room temperature. The open circuit voltage (OCV) and independence of the battery cell at that point was 0.765 volts and 18.69 milliohms, respectively. The aged battery cell then undergoes a formation process that includes being charged first at C/40 with 300 milliampere hours (mAh) and aging for 7 days at room temperature.

Sample Cell I was tested for its capacity, direct current resistance (DCR), and cycle life before and after zero-voltage exposure. To test Sample Cell I for its capacity and direct current resistance (DCR), Sample Cell I was rested for 2 hours before being charged at a constant current and constant voltage (CC-CV) at C/5 to 4.4 volts until C/20. Once charged, Sample Cell I was rested for 10 minutes before being discharged at a constant current (CCD) at C/2 for 5 minutes to approximately 95% state of charge (SOC). A first voltage measurement V₁ and first current measurement I₁ was made 10 seconds prior to the end of the discharge. Sample Cell I was then again subjected to a constant current discharge (CCD) at C/5 for 1 minute before a second voltage measurement V₂ and current measurement I₂ was made 10 seconds into the second discharge. The direct current resistance (DCR) of Sample Cell I at 95% state of charge (SOC) corresponds to DCR_{95% soc}=|(V₂− V₁)/(I₂−I₁)|.

Sample Cell I was again subjected to a constant current discharge (CCD) at C/2 for 54 minutes to reach approximately a 50% state of charge (SOC). A third voltage measurement V₃ and third current measurement I₃ was performed 10 seconds prior to the end the discharge. Sample Cell I was subjected to constant current discharge (CCD) at C/5 for 1 minute before a fourth voltage measurement V₄ and fourth current measurement I₄ was performed 10 seconds into this discharge. The direct current resistance of Sample Cell I at 50% state of charge (SOC) may correspond to DCR_{50% soc}=| (V₄− V₃)/(I₄− I₃)|.

Sample Cell I was thereafter subjected again to a constant current discharge (CCD) at C/2 for 36 minutes to reach approximately a 20% state of charge (SOC). A fifth voltage measurement V₅ and fifth current measurement I₅ may be performed 10 seconds prior to the end of this discharge. Sample Cell I was then be subjected to a constant current discharge (CCD) at C/5 for 1 minute before a sixth voltage measurement V₆ and sixth current measurement I₆ was performed approximately 10 seconds into this discharge. The direct current resistance (DCR) of Sample Cell I at 20% state of charge corresponds to DCR_{20% soc}=|(V₆− V₅)/(I₆− I₅)|. The discharge capacity/energy, coulombic/energy efficiency, and direct current resistance (DCR) of Sample Cell I were recorded.

Zero-voltage stability of Sample Cell I was evaluated by subjecting Sample Cell I to zero-voltage exposure. This included charging Sample Cell I at a constant current and constant voltage (CC—CV) at C/5 to 4.4 volts until <C/20, resting Sample Cell I for 10 minutes rest, subjecting Sample Cell I to a constant current discharge (CCD) at C/5 to 2.5 volts, resting Sample Cell I for 30 minutes, subjecting Sample Cell I to another constant current discharge (CCD) at C/5 to 0 volts, discharging Sample Cell I at 20 ohms and 0 volts for 7 days, charging Sample Cell I at a constant current and constant voltage (CC—CV) at C/5 to 3.8 volts, and resting Sample Cell I for 24 hours before measuring the capacity and direct current resistance (DCR) of Sample Cell I at 20° C.

The cycle life of Sample Cell I at 20% depth of discharge (DOD) was evaluated by resting Sample Cell I for 2 hours, charging Sample Cell I at a constant current and constant voltage (CC—CV) at C/5 to 4.1 volts until <C/20, subjecting Sample Cell I to a constant current discharge (CCD) at C/1.5 for 35 minutes to reach a 20% depth of discharge (DOD), again charging Sample Cell I at a constant current at C/2.25 to 4.1 volts until <C/20, and repeating until Sample Cell I reaches an end of discharge voltage (EODV) of 2.5 volts. The capacity and direct current resistance (DCR) of Sample Cell I at 20% depth of discharge (DOD) was measured at every 200 cycles.

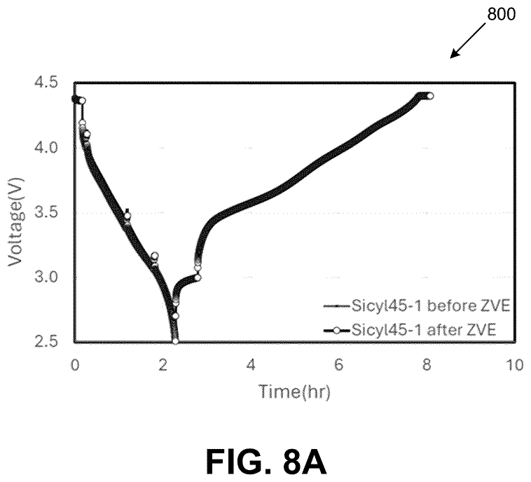

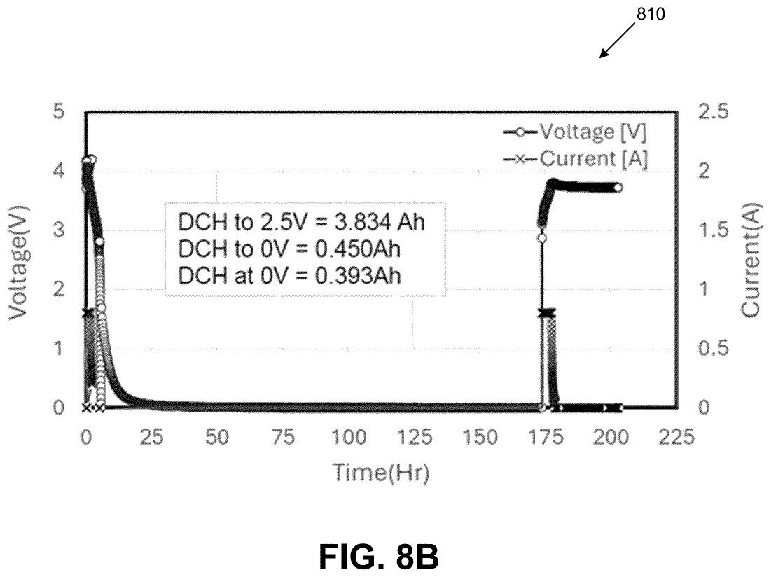

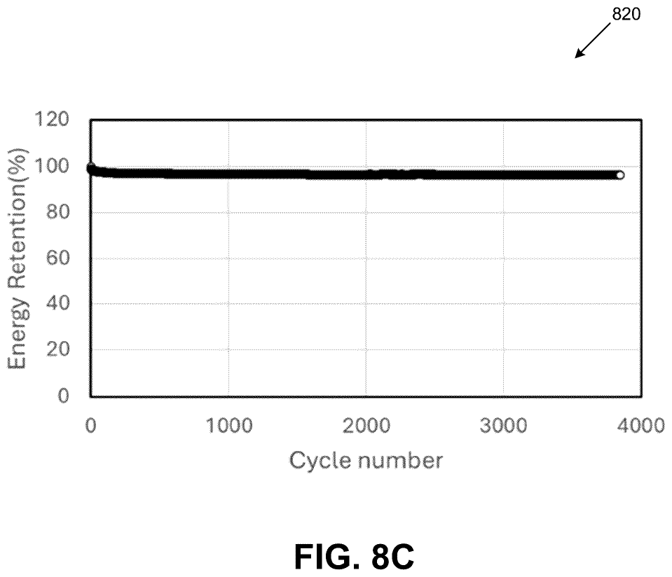

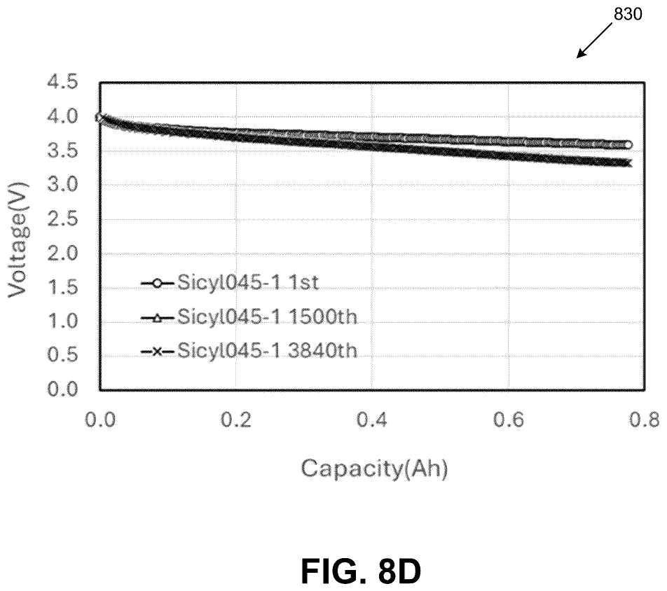

The results show that Sample Cell I, which incorporates a non-lithium sacrificial material in the form of a zinc (Zn) disk, maintained its capacity and cycle life despite prolonged zero voltage exposure. FIG. 8A depicts a graph 800 showing the capacity and direct current resistance (DCR) of Sample Cell I before and after zero-voltage exposure. FIG. 8B depicts a graph 810 illustrating the voltage profile of Sample Cell I during the course of zero-voltage exposure (7 days at 20 omhs). FIG. 8C depicts a graph 820 illustrating the cycle life of Sample Cell I (20% depth of discharge (DoD)) after zero-voltage exposure. FIG. 8D depicts a graph 830 illustrating the voltage-capacity profiles of Sample Cell I at 20% depth of discharge (DoD).

Table 2 below depicts the change in the capacity and direct current resistance of Sample Cell I before and after zero-voltage exposure.

TABLE 2

| Parameter | Before ZVE | After ZVE | Δ (%) |
|---|---|---|---|
| Charge Capacity/Ah | 4.15 | 4.13 | −0.66 |
| Discharge Capacity/Ah | 4.16 | 4.14 | −0.43 |
| Charge Energy/Wh | 16.02 | 15.91 | −0.72 |
| Discharge Energy/Wh | 14.10 | 13.90 | −1.44 |
| C.E./% | 99.94 | 100.18 | 0.23 |
| E.E./% | 87.98 | 87.34 | −0.72 |
| DCR_95%/mΩ | 71.66 | 76.25 | 6.39 |
| DCR_50%/mΩ | 67.91 | 72.58 | 6.87 |

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for producing a battery cell, comprising:
forming a positive electrode;
forming a negative electrode;
interposing a separator between the positive electrode and the negative electrode to form a sheet of materials;
securing, to a case, a disk comprising a non-lithium sacrificial material;
inserting, into the case, the sheet of materials;
extending, through an opening in the disk, a negative tab extending from the negative electrode; and
welding the negative tab to the disk and the case to provide (i) an electrical connection between the negative electrode and the non-lithium sacrificial material, and (ii) an electrical connection between the negative electrode and a negative terminal of the battery cell.

2. The method of claim 1, wherein the forming of the positive electrode includes applying, to a metal foil comprising a positive current collector, a slurry including one or more materials comprising the positive electrode.

3. The method of claim 1, wherein the forming of the negative electrode includes applying, to a metal foil comprising a negative current collector, a slurry including one or more materials comprising the negative electrode.

4. The method of claim 3, wherein the non-lithium sacrificial material has a lower decomposition voltage than the metal foil comprising the negative current collector.

5. The method of claim 3, wherein the metal foil comprising the negative current collector is a copper (Cu) foil, and wherein the non-lithium sacrificial material is zinc (Zn).

6. The method of claim 1, further comprising:
wounding the sheet of materials including the separator interposed between the positive electrode and the negative electrode to form a jellyroll; and
inserting, into the case of the battery cell, the jellyroll.

7. The method of claim 1, further comprising:
inserting, into a case, a layer of insulator material such that the insulator material is interposed between the disk of the non-lithium sacrificial material and the sheet of materials including the separator interposed between the positive electrode and the negative electrode.

8. The method of claim 1, wherein the disk includes an insulator material layered with the non-lithium sacrificial material, and wherein the disk is secured to the case with the insulator material interposed between the non-lithium sacrificial material and the sheet of materials including the separator interposed between the positive electrode and the negative electrode.

9. The method of claim 1, further comprising:
welding, to the case, a positive tab extending from the positive electrode, the positive tab is weld to a positive terminal of the battery cell while the negative tab is weld to a negative terminal of the battery cell.

10. The method of claim 1, further comprising:
filling the case with an electrolyte before sealing the case.
